(19) United States
(12) Patent Application Publication
(10) Pub. No.: US 2009/0287856 A1
(43) Pub. Date: Nov. 19, 2009

(54) INFORMATION PROCESSING APPARATUS HAVING CONNECTOR AND METHOD OF CONTROLLING THE SAME

(75) Inventor: Masayuki Ito, Nagoya-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/437,134

(22) Filed: May 7, 2009

(30) Foreign Application Priority Data
May 16, 2008 (JP) 2008-129727

(51) Int. Cl. G06F 3/00

(52) U.S. Cl. 710/19

(57) ABSTRACT

Whether a USB icon button is pressed or not is determined. If determined, a USB device status table in a USB device monitoring unit is referred to. Based on information in the USB device status table, a rank determination is executed. After the rank determination, the priority to recommend disconnection from a USB connector is then set based on the rank determination result. Then, a USB device priority screen is displayed.

This application is based on Japanese Patent Application No. 2008-129727 filed with the Japan Patent Office on May 16, 2008, the entire content of which is hereby incorporated by reference.

### BACKGROUND OF THE INVENTION

1. Field of the Invention

The present invention relates to an information processing apparatus and a method of controlling the same, and more particularly to an information processing apparatus having a USB connector to which a USB (Universal Serial Bus) device can be connected and a method of controlling the same.

2. Description of the Related Art

In recent years, a variety of devices can be connected to USB connectors, and in PC (Personal Computer), generally, more and more USB devices are sold in sets together with applications running on OS (Operation System).

Examples include USB memories, USB-HDD (Hard Disk Drive), USB-DVD (Digital Versatile Disk), USB authentication devices, digital cameras (including digital video cameras) capable of data communications using a USB cable, and the like. For example, as for digital cameras, Japanese Laid-Open Patent Publication No. 2002-218300 discloses a technique of improving convenience by setting a PC (Personal Computer) and a cradle in a communicable state using a USB cable and then mounting a digital camera on the cradle.

There is a high possibility that once these USB devices are connected to USB connectors, the connected state is maintained. Therefore, even when a PC, for example, is provided with a plurality of USB connectors, all the USB connectors may be in the attached state.

Since in this situation it is difficult to attach an additional USB device to the USB connector, a USB hub may be purchased in order to increase the total number of USB devices to be connected to the USB connectors. However, this is a problem in terms of costs because it is necessary to purchase a USB hub.

On the other hand, in general, some USB devices are not actually used even when all the USB connectors are in the attached state, and therefore, in many cases, there is no problem in detaching the USB devices connected to the USB connectors.

When the USB device attached to a USB connector is temporarily detached and another USB device is attached, however, with increasing number of USB devices, it is difficult to determine at a glance the USB device connected to which USB connector can be detached, and it is necessary to find the connected device and then examine the operational state and the like.

Therefore, cumbersome operations are required for the users, which is inconvenient.

### SUMMARY OF THE INVENTION

The present invention is therefore made to solve the aforementioned problems. An object of the present invention is to provide an information processing apparatus having a plurality of USB connectors to which a plurality of USB devices can be connected, in which the USB connectors can be used efficiently and effectively and a method of controlling the same.

An information processing apparatus in accordance with the present invention includes: a display unit; a plurality of connectors to each of which a removable device can be attached; a state monitoring unit for monitoring a state of the plurality of connectors; and a control unit for setting, based on a power state of the connector to which a removable device is attached among the plurality of connectors monitored by the state monitoring unit, a priority indicating a degree to which a corresponding removable device can be disconnected preferentially, and displaying said set priority on the display unit.

Preferably, the state monitoring unit senses that the plurality of removable devices are attached to all of the plurality of connectors. The control unit displays on the display unit the priority of the corresponding removable device attached to each of the plurality of connectors, according to a sensing result from the state monitoring unit.

Preferably, the state monitoring unit has information of removal history of the removable device attached in the past, for the connector to which a removable device is attached among the plurality of connectors. The control unit determines a removal frequency based on information of the removal history of the connector that is not powered, for the connector having the removable device attached thereto, among the plurality of connectors, and sets the priority high for the corresponding removable device attached to the connector with a high removal frequency.

Preferably, the state monitoring unit additionally monitors an access state to the corresponding removable device, for the connector to which a removable device is attached among the plurality of connectors. If the connector having the removable device attached thereto, among the plurality of connectors, is powered, the control unit determines whether the corresponding removable device is in an accessed state or not, and sets the priority higher for the corresponding removable device that is not in the accessed state than in the accessed state.

In particular, the state monitoring unit has information of an equipment kind of the corresponding removable device, for the connector to which a removable device is attached among the plurality of connectors. If the connector to which a removable device is attached among the plurality of connectors, is powered and the corresponding removable device is not in the accessed state, the control unit determines the equipment kind of the corresponding removable device and sets the priority based on a result of the determination.

Preferably, the control unit displays models of the plurality of connectors on the display unit and also displays the priority in connection with the models of the plurality of connectors.

Preferably, the state monitoring unit has information of removal history of the removable device attached in the past, for the connector to which a removable device is attached among the plurality of connectors. The control unit displays on the display unit the priority of the removable device corresponding to the connector that is not powered, for the connector to which a removable device is attached among the plurality of connectors, and also displays information of removal history of the removable device attached in the past.

In accordance with another aspect of the present invention, a method of controlling an information processing apparatus provided with a display unit and a plurality of connectors to each of which a removable device can be attached includes the steps of: monitoring a state of the plurality of connectors; setting, based on a power state of the connector to which a removable device is attached among the monitored plurality of connectors, a priority indicating a degree to which a corresponding removable device can be disconnected preferentially, and displaying the set priority on the display unit.

An information processing apparatus and a method of controlling the same in accordance with the present invention monitors the state of a plurality of connectors, sets a priority indicating a degree to which a corresponding removable device can be disconnected preferentially, based on the power state of the connector having a removable device attached thereto among a plurality of connectors, and displays the priority on a display unit. The display allows the user to grasp at a glance a removable device that can be disconnected, thereby to efficiently and effectively use the USB connectors as attachment/removal units.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of a PC as an example of information processing apparatus in accordance with an embodiment of the present invention.

FIG. 2 illustrates an exemplary screen appearing on a display unit 5 in accordance with the embodiment of the present invention.

FIG. 3 is a flowchart illustrating a process of displaying a priority to recommend disconnecting a USB device from a USB connector in accordance with the embodiment of the present invention.

FIG. 4 illustrates an exemplary USB device status table.

FIG. 5 is a flowchart of executing a rank determination.

FIG. 6 illustrates an exemplary USB device priority screen based on information of the USB device status table in FIG. 4.

FIG. 7 illustrates another USB device priority screen based on information of the USB device status table in FIG. 4.

### DESCRIPTION OF THE PREFERRED EMBODIMENT

In the following, an embodiment of the present invention will be described with reference to the figures. It is noted that in the following description, the same parts and components are denoted with the same reference characters. They have the same designations and functions.

(Configuration of PC)

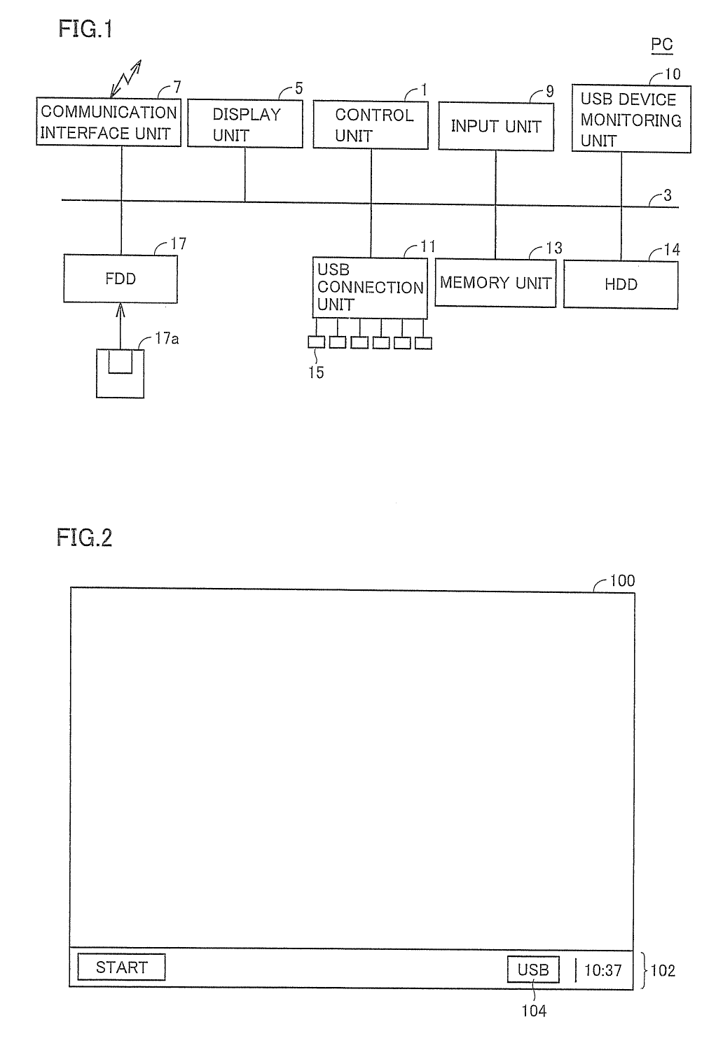

Using FIG. 1, a PC as an example of information processing apparatus in accordance with an embodiment of the present invention will be described.

Referring to FIG. 1, a PC in accordance with the embodiment of the present invention includes a control unit 1 formed of a CPU (Central Processing Unit) executing a variety of programs including an operating system (OS), a memory unit 13 temporarily storing data necessary to execute the programs in control unit 1, and a hard disk unit (HDD: Hard Disk Drive) 14 storing the programs to be executed in control unit 1 in a nonvolatile manner. Such programs are read from a flexible disk 17a by a floppy disk drive 17 (FDD).

Control unit 1 accepts an instruction from the user through an input unit 9 formed of a keyboard, a mouse, or the like and also outputs to a display unit 5 a screen output generated by execution of a program.

Control unit 1 may also execute communication processing with an external device via an external network through a communication interface unit 7 formed of a LAN (Local Area Network) card or the like.

The units described above communicate data with each other through an internal bus 3.

The PC further includes USB connectors 15 to which a plurality of USB devices can be connected, a USB connection unit 11 controlling electrical connection of the USB devices attached to the USB connectors, and a USB device monitoring unit 10 monitoring the state of the USB devices attached to USB connectors 15.

USB device monitoring unit 10 monitors the states of the USB devices attached to USB connectors 15 and stores in an internal USB device status table equipment kinds, on/off of power, a job state, and history information of USB devices attached to USB connectors 15.

Using FIG. 2, an exemplary screen appearing on display unit 5 in accordance with the embodiment of the present invention will be described.

Referring to FIG. 2, a screen 100 includes a task bar 102 displayed in the bottom field region, in which a USB icon button 104 is displayed together with a start button for starting application software and a clock.

In order to display USB icon button 104, USB device monitoring unit 10 senses a state in which USB devices are attached to all of a plurality of USB connectors 15 and outputs this state to control unit 1. Control unit 1 then receives the sensing result from USB device monitoring unit 10 and allows USB icon button 104 to show up on screen 100 appearing on display unit 5.

A process of displaying on the screen the priorities to recommend disconnecting the USB devices respectively attached to a plurality of USB connectors 15 from the USB connectors is then executed, for example, by clicking USB icon button 104 using a not-shown mouse or the like for execution.

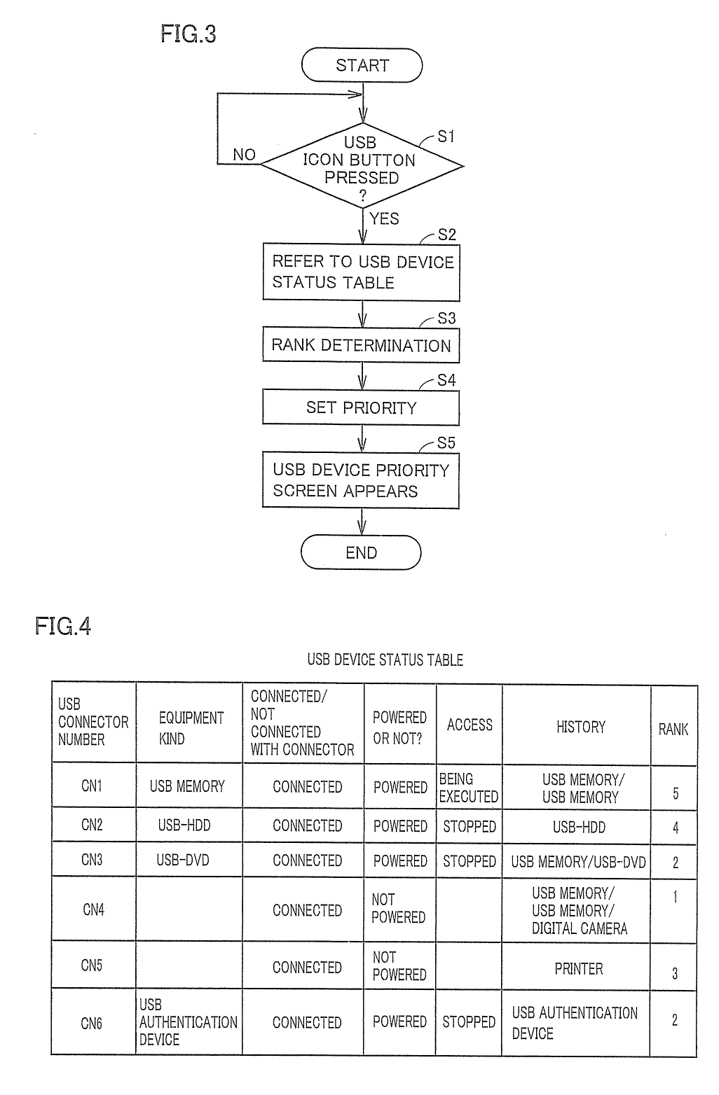

Using FIG. 3, a process of displaying a priority to recommend disconnecting a USB device from a USB connector in accordance with the embodiment of the present invention will be described.

Referring to FIG. 3, an input is sensed by determining whether or not USB icon button 104 is pressed in screen 100 (step S1), and if it is determined that an input is made, control unit 1 executes the process of displaying a priority to recommend disconnection from the USB connector as described in detail below.

Control unit 1 then refers to the USB device status table stored in USB device monitoring unit 10 (step S2).

Using FIG. 4, an exemplary USB device status table will be described.

Referring to FIG. 4, here, the fields of USB connector numbers CN1-CN6 are provided corresponding to the respective USB connectors 15. Then, in this case, corresponding to the items of each USB connector number, “equipment kind,” “connected/not connected with connector,” “powered or not,” “access state,” “history,” and “rank” are displayed. Although “rank” is displayed here, the “rank” field may be provided or may not be provided specially.

Specifically, in this example, equipment information indicating that the USB device connected to USB connector 15 is a USB memory, a USB-HDD, a USB-DVD, a USB authentication device, or the like is stored in “equipment kind,” USB connection unit 11 obtains equipment information of the USB device attached through USB connector 15 and outputs the same to USB device monitoring unit 10. USB device monitoring unit 10 then stores the equipment information of the USB device in the field corresponding to the USB connector number. It is noted that in a case of the power-off state, the equipment information of the USB device cannot be obtained and the equipment information is therefore not output to USB device monitoring unit 10.

Furthermore, information as to whether a USB device is connected to USB connector 15 or not is stored in “connected/not connected with connector.” USB connection unit 11 senses whether the USB device attached through USB connector 15 is connected or not and then outputs the sensing information to USB device monitoring unit 10. USB device monitoring unit 10 then stores the information as to whether USB device is connected or not, in the field corresponding to the USB connector number.

Then, if the information of being connected is stored in all the USB connector number fields, USB device monitoring unit 10 determines that it is a state in which all of a plurality of USB connectors 15 have USB devices attached thereto, and outputs the state to control unit 1, as described above. Control unit 1 then allows USB icon button 104 to show up on screen 100, as described above.

Furthermore, information as to whether the USB device attached to USB connector 15 is powered or not is stored in “powered or not.”

For example, when a USB memory, a USB-DVD, or a USB authentication device is attached to USB connector 15, power is supplied from the main body (PC) through USB connector 15 for operation, and therefore the USB device is powered on when being attached to USB connector 15.

On the other hand, a USB-HDD, a printer, or a digital camera does not receive power supply from the main body (PC) but receives power supply separately and independently from a power supply line provided on the USB device side and operates in accordance with power supply control on the USB device side. Therefore, the USB device is not powered merely by being attached to USB connector 15. Theses USB devices are powered on by turning on the power on the USB device side.

USB connection unit 11 senses whether power is supplied or not to the USB device attached through USB connector 15 and outputs the sensing information to USB device monitoring unit 10. USB device monitoring unit 10 then stores the information as to whether the USB device is powered or not, in each of the fields corresponding to USB connector numbers CN1-CN6.

Information as to whether access to the USB device is now being executed or not executed, that is, stopped, is stored in “access state.”

If access to the USB device attached through USB connector 15 is being executed, USB connection unit 11 outputs the information to USB device monitoring unit 10. USB device monitoring unit 10 then stores the access state of the USB device in the field corresponding to the USB connector number. Specifically, that access is being executed is stored. On the other hand, when the access is ended, the information is output to USB device monitoring unit 10. USB device monitoring unit 10 stores the information that the access is being stopped.

History information of the equipment kinds of USB devices attached in the past to the USB connectors respectively corresponding to USB connector numbers CN1 CN6 is stored in “history.” Specifically, USB device monitoring unit 10 accumulates the equipment information of the USB devices attached to the USB connector that is output from USB connection unit 11 during a prescribed period of time in the past and stores the accumulated equipment information as history information. In this example, the attached USB devices are shown each separated by symbol “/” and the one on the right is the latest history information. A prescribed period of time is, for example, determined as the past three days.

The result of making a rank determination by referring to the USB device status table is stored in “rank” as described later.

In this example, as for USB connector number CN1, information indicating a USB memory is stored in “equipment kind,” “power state” indicates being powered, “access state” indicates that access is being executed, and history information indicating that a USB memory has been attached twice in a row in the past is stored in “history,” by way of example.

As for USB connector number CN2, information indicating a USB-HDD is stored as “equipment kind,” “connected/not connected with connector” indicates being connected, “power state” indicates being powered, “access state” indicates being stopped, and history information indicating that USB-HDD has been attached in the past is stored as “history.”

As for USB connector number CN3, information indicating a USB-DVD is stored as “equipment kind,” “connected/not connected with connector” indicates being connected, “power state” indicates being powered, “access state” indicates being stopped, and history information indicating that a USB memory has been attached and then a USB-DVD has been attached in the past is stored as “history,”

As for USB connector number CN4, no information is stored as “equipment kind,” “connected/not connected with connector” indicates being connected, “power state” indicates not being powered, “access state” has also no information stored therein, and history information indicating that a USB memory has been attached twice and then a digital camera has been attached in the past is stored as “history,”

As for USB connector number CN5, no information is stored as “equipment kind,” “connected/not connected with connector” indicates being connected, “power state” indicates not being powered, “access state” has also no information stored therein, and history information indicating that a printer has been attached in the past is stored as “history.”

As for USB connector number CN6, information indicating a USB authentication device is stored as “equipment kind,” “connected/not connected with connector” indicates being connected, “power state” indicates being powered, “access state” indicates being stopped, and history information indicating that a USB authentication device has been attached is stored as “history,”

Referring to FIG. 3 again, next, a rank determination is executed based on the information in the USB device status table (step S3). In the embodiment of the present invention, the order of priority to recommend disconnecting a USB device from a USB connector is determined based on whether powered or not, whether being accessed or not, whether attachment/removal is frequent or not, and the USB equipment kind. In this example, a classification is made into Ranks 1-5, by way of example.

Rank 1 is set as the top priority to recommend disconnecting a USB device from a USB connector. The lower priorities are given in ascending order, and Rank 5 is set as the lowest priority to recommend disconnecting a USB device from a USB connector.

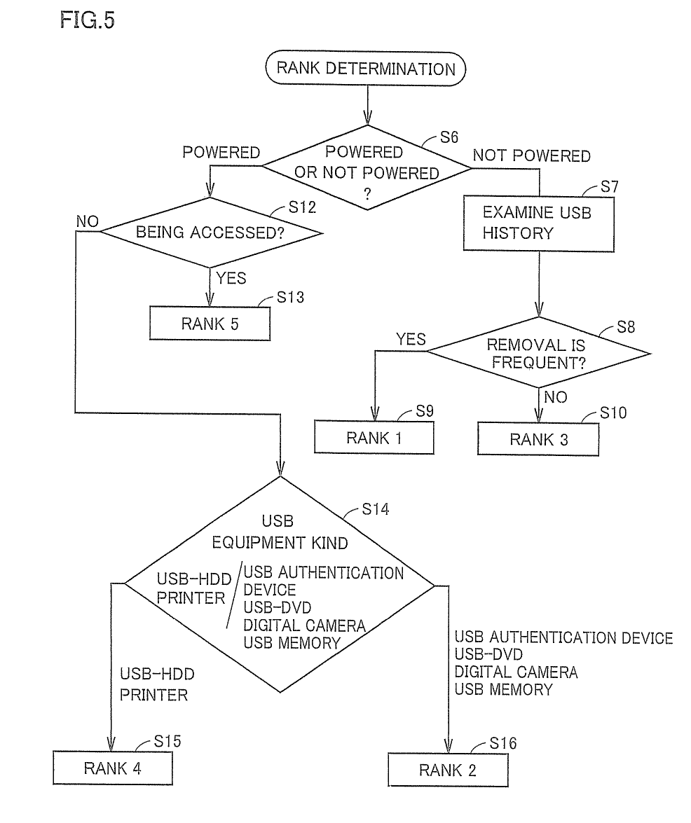

Using FIG. 5, a flowchart of executing a rank determination will be described.

Referring to FIG. 5, in the rank determination process, first, whether powered or not is determined (step S6).

If being powered is determined in step S6, the process proceeds to step S12. On the other hand, if not being powered is determined in step S6, the process proceeds to step S7.

If being powered is determined in step S6, it is determined whether being accessed or not in step S12 (step S12). If being accessed, the process proceeds to step S13, and Rank 5 is set. When the USB device is being accessed, it is not preferable to disconnect the USB device from the USB connector, because disconnection of the USB device from the USB connector causes an error in the processing for the USB device and also may cause a failure, and then Rank 5 which is the lowest priority is set.

On the other hand, if not being accessed, that is, if being stopped, in step S12, the process proceeds to the next step S14.

In step S14, the kind of USB equipment attached to the USB connector is determined (step S14).

In a case of a USB authentication device, a USB-DVD, a digital camera, or a USB memory as a result of determining the USB equipment kind in step S14, the process proceeds to step S16, and Rank 2 is set.

On the other hand, in a case of a USB-HDD or a printer as a result of determining the USB equipment kind in step S14, the process proceeds to step S15, and Rank 4 is set.

If the access to the USB device is being stopped, although there is no problem in disconnecting the USB device from the USB connector, some equipment kinds of USB devices are likely to be used as fixed devices. Therefore, for USB-HDD and printers which are likely used as fixed devices that are less frequently inserted/disconnected, a lower priority is set as Rank 4. On the other hand, for USB memories and the like which are, in general, likely to be used as portable removal storage devices and may be inserted/disconnected more frequently than the fixed usage, Rank 2 is set.

On the other hand, if not being powered is determined in step S6, then USB history is examined (step S7). Then, whether the removal frequency of the USB device attached to the USB connector is high or not is determined based on the “history” information in the USB device status table (step S8). In this example, it is determined that the removal frequency is high, for example, if the history information of the USB device being removed from/attached to the USB connector three times less than or equal to in the past prescribed period of time, three days, is stored.

If it is determined that the removal frequency is high in step S8, the process proceeds to step S9, and Rank 1 is set. On the other hand, if it is determined that the removal frequency is not high, that is, the device is fixedly used, in step S8, the process proceeds to step S10, and Rank 3 is set.

When the USB device is not powered, disconnection of the USB device from the USB connector is not a problem. However, though not being powered, some USB devices attached to the USB connectors are likely to be fixedly used. In this case, it is inconvenient for the user to disconnect from the USB connector the USB device that is fixedly used though not being powered, because the USB device is likely to be attached again.

Therefore, whether the USB device is fixedly used or not is determined according to the removal frequency by examining the history information of the USB device attached to the USB connector in the past. Rank 3 is set and a low priority is then set, for the USB device attached to the USB connector that is likely to be fixedly used, that is, less frequently inserted/disconnected. On the other hand, Rank 1 is set for the USB device attached to the USB connector that is determined as being attached/removed frequently, that is, inserted/disconnected frequently.

Referring to FIG. 3 again, after the rank determination in step S3, next, the priority to recommend disconnecting the USB device from the USB connector is set based on the rank determination result (step S4). Specifically, the first priority is given to the rank having a small number as a result of the rank determination. Then, the second priority is given to the rank having the next smallest number. Thereafter, in the same way, the priorities are set in ascending order, based on the numbers of the rank determination result. In case where a plurality of connector numbers having the same rank exist as a result of the rank determination, the same priority may be set and displayed. Alternatively, the time period during which the USB device is attached is measured, and different priorities may be set respectively corresponding to the USB connector numbers, according to the measured time. Specifically, a lower priority may be set to the one having the longer attached time.

Then, a USB device priority screen appears on display unit 5 (step S5).

Specifically, for the USB devices attached corresponding to the above-mentioned USB connectors, the priority to recommend disconnection from the USB connector based on the rank determination is displayed.

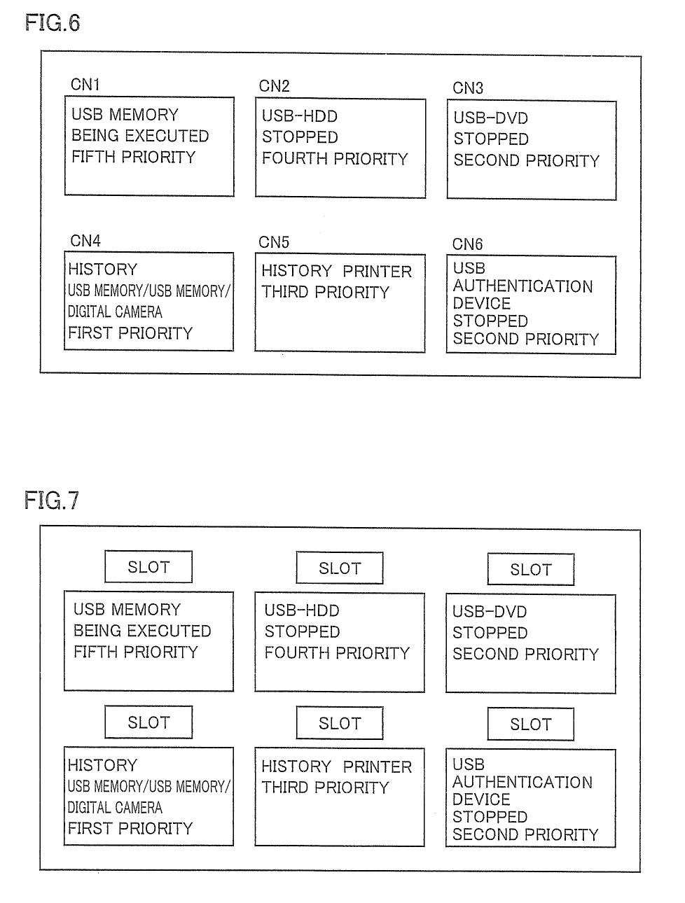

Using FIG. 6, the USB device priority screen based on the information of the USB device status table in FIG. 4 will be described.

As shown in FIG. 6, the priorities based on the rank determination result as described above are displayed corresponding to the respective six USB connectors, together with the equipment kinds of the USB devices connected to the respective connectors and the access state. Specifically, the USB device that is attached to the USB connector having history of USB memory/USB memory/digital camera corresponding to USB connector number CN4 has the first priority. The USB-DVD attached to the USB connector corresponding to USB connector number CN3 has the second priority. The USB authentication device attached to the USB connector corresponding to USB connector number CN6 has the second priority. The USB device attached to the USB connector having history of printer corresponding to USB connector number CN5 has the third priority. The USB-HDD attached to the USB connector corresponding to USB connector number CN2 has the fourth priority. The USB memory attached to the USB connector corresponding to USB connector number CN1 has the fifth priority.

The screen display allows the user to recognize the priority to recommend disconnecting the USB device attached to each USB connector from the USB connector, and, for example, to determine to preferentially disconnect the USB device attached to the USB connector corresponding to USB connector number CN4 having a high priority.

In this example, USB memory/USB memory/digital camera is stored in the USB device status table as the history information of the USB device attached to the USB connector corresponding to USB connector number CN4, and Rank 1 is set. Accordingly, it can be determined to preferentially disconnect from the USB connector the digital camera that is considered to be attached as the USB device. In addition, to display whether being accessed or not prevents the user from erroneously disconnecting the USB device that is being accessed.

Moreover, because of displaying the history information, it is possible to easily guess the USB device connected to the USB connector even when the USB device is not powered.

Accordingly, it is possible to efficiently and effectively use a plurality of connectors to which USB devices can be connected.

Although in this example, the order is displayed in the screen display to allow the user to recognize the priority to recommend disconnecting the USB device attached each USB connector from the USB connector, the present invention is not limited to such a manner as long as it is possible to allow the user to recognize the priority to recommend disconnecting the USB device from the USB connector. For example, it is possible to notify the user of the information of the USB device that can be disconnected preferentially by distinguishing each priority by color or gradation. Alternatively, it is also possible to blink the USB device that can be disconnected preferentially or to highlight the USB device that is not appropriate to be disconnected preferentially, in terms of rank.

### Modified Embodiment

Using FIG. 7, a USB device priority screen based on the information of the USB device status table in FIG. 4 will be described.

As shown in FIG. 7, the USB device priority screen displayed together with the slot models of the USB connectors allows the user to see at a glance the USB device attached to which USB connector can be disconnected, in comparison to the configuration of the USB connectors of the PC body, thereby improving the user's convenience. In addition, the screen display can prevent erroneous disconnection of the USB device that is being accessed.

Here, a PC provided with six connectors as USB connectors has been described. The present invention, however, is not limited thereto, and the number is not limited as long as more than one connectors are provided.

The information processing apparatus in accordance with the present invention is not limited to a PC and may be a printer, a facsimile, an MFP (Multi Function Peripheral), or the like as long as the information processing apparatus has a plurality of USB connectors. For a controller controlling the image formation apparatus, a program may be provided which allows a computer to function to execute the control as described in the above-noted flows. Such a program may be recorded in a computer readable recording medium such as a flexible disk, a CD-ROM (Compact Disk-Read Only Memory), a ROM (Read Only Memory), a RAM (Random Access Memory), and a memory card, which accompanies a computer, and be provided as a program product. Alternatively, the program may be recorded in a recording medium such as a hard disk contained in a computer. Alternatively, the program may be downloaded via a network.

The program in accordance with the present invention may allow the process to be executed by invoking necessary modules, among program modules provided as a part of Operation System (OS) of a computer, in a prescribed sequence at a prescribed timing. In this case, the aforementioned modules are not included in the program itself and the process is executed in cooperation with OS. The program that does not include such modules may also be included in the program in accordance with the present invention.

Furthermore, the program in accordance with the present invention may be built in a part of another program. In this case, the modules included in another program are not included in the program itself, and the process is executed in cooperation with another program. Such a program built in another program may also be included in the program in accordance with the present invention.

The program product to be provided is installed in a program storage portion such as a hard disk for execution. It is noted that the program product includes the program itself and a recording medium having the program recorded thereon.

Although the present invention has been described and illustrated in detail, it is clearly understood that the same is by way of illustration and example only and is not to be taken by way of limitation, the scope of the present invention being interpreted by the terms of the appended claims.

What is claimed is:

1. An information processing apparatus comprising:
a display unit;
a plurality of connectors to each of which a removable device can be attached;
a state monitoring unit for monitoring a state of said plurality of connectors; and
a control unit for setting, based on a power state of the connector to which a removable device is attached among said plurality of connectors monitored by said state monitoring unit, a priority indicating a degree to which a corresponding removable device can be disconnected preferentially, and displaying said set priority on said display unit.

2. The information processing apparatus according to claim 1, wherein
said state monitoring unit senses that said plurality of removable devices are attached to all of said plurality of connectors, and
said control unit displays on said display unit said priority of the corresponding removable device attached to each of said plurality of connectors, according to a sensing result from said state monitoring unit.

3. The information processing apparatus according to claim 1, wherein
said state monitoring unit has information of removal history of the removable device attached in the past, for the connector to which a removable device is attached among said plurality of connectors, and
said control unit determines a removal frequency based on information of the removal history of the connector that is not powered, for the connector having said removable device attached thereto, among said plurality of connectors, and sets said priority high for the corresponding removable device attached to the connector with a high removal frequency.

4. The information processing apparatus according to claim 1, wherein
said state monitoring unit additionally monitors an access state to the corresponding removable device, for the connector to which a removable device is attached among said plurality of connectors, and
if the connector having said removable device attached thereto, among said plurality of connectors, is powered, said control unit determines whether the corresponding removable device is in an accessed state or not, and sets said priority higher for the corresponding removable device that is not in the accessed state than in the accessed state.

5. The information processing apparatus according to claim 4, wherein
said state monitoring unit has information of an equipment kind of the corresponding removable device, for the connector to which a removable device is attached among said plurality of connectors, and
if the connector to which a removable device is attached among said plurality of connectors is powered and said corresponding removable device is not in the accessed state, said control unit determines the equipment kind of said corresponding removable device and sets said priority based on a result of the determination.

6. The information processing apparatus according to claim 1, wherein said control unit displays models of said plurality of connectors on said display unit and also displays said priority in connection with the models of said plurality of connectors.

7. The information processing apparatus according to claim 1, wherein
said state monitoring unit has information of removal history of the removable device attached in the past, for the connector to which a removable device is attached among said plurality of connectors, and
said control unit displays on said display unit said priority of the removable device corresponding to the connector that is not powered, for the connector to which a removable device is attached among said plurality of connectors, and also displays information of removal history of the removable device attached in the past.

8. A method of controlling an information processing apparatus provided with a display unit and a plurality of connectors to each of which a removable device can be attached, the method comprising the steps of:
monitoring a state of said plurality of connectors;
setting, based on a power state of the connector to which a removable device is attached among said monitored said plurality of connectors, a priority indicating a degree to which a corresponding removable device can be disconnected preferentially, and
displaying said set priority on said display unit.
